(19) United States
(12) Patent Application Publication
(10) Pub. No.: US 2020/0250940 A1
(43) Pub. Date: Aug. 6, 2020

(54) SHORT RANGE COMMUNICATION DEVICE AND RELATED METHODS

(71) Applicants: William Davis, Orem, UT (US); Morgen Glessing, Orem, UT (US)

(72) Inventors: William Davis, Orem, UT (US); Morgen Glessing, Orem, UT (US)

(21) Appl. No.: 16/776,124

(22) Filed: Jan. 29, 2020

Related U.S. Application Data
(60) Provisional application No. 62/799,897, filed on Feb. 1, 2019.

(51) Int. Cl. G08B 5/22; H04W 4/80; H02J 50/80; H04W 4/30; H04B 1/401; H04B 1/3827

(52) U.S. Cl. CPC G08B 5/224; H04W 4/80; H04B 1/385; H04W 4/30; H04B 1/401; H02J 50/80

(57) ABSTRACT

In one example, a wireless communication device includes a receiver, a transmitter, a power source connected to the transmitter and receiver, and a group of user-selectable status indicators, each of which are selectable by a user to cause the transmitter to transmit a respective status signal. The use-selectable status indicators include a respective user-selectable status indicator for each of the following statuses: ‘on belay’; ‘off belay’; ‘climb’; ‘take’; and ‘slack.’

### RELATED APPLICATIONS

This application hereby claims priority to U.S. Provisional Patent Application, Ser. 62/799,897, entitled SHORT RANGE COMMUNICATION DEVICE AND RELATED METHODS, and filed Feb. 1, 2019. All of the aforementioned applications are incorporated herein in their respective entireties by this reference.

### TECHNICAL FIELD

The present disclosure relates generally to short range communication devices and related assemblies, systems, and methods.

### BACKGROUND

Currently, communication devices employ technologies designed for global or long-distance communication. However, such devices and related systems often leave users without a connection, or only an unreliable connection, in outdoor environments where communication services may not be available, or are only available on an unpredictable basis, and in areas where high, and/or complex, physical obstructions are present. To illustrate, Family Radio Service (FRS) radios have been used in some applications but may not provide satisfactory performance in environments that present challenges such as physical obstructions and extreme weather. The shortcomings of systems and devices such as those conforming to the FRS standard have compelled users to resort to verbal communication and other non-technical forms of communication in order to be able to communicate in circumstances and environments for which FRS is not well suited. However, the use of verbal communication is an unsatisfactory solution, as the parties involved may not always be able to hear each other due to weather and other noises. Moreover, a verbal communication, even if perceived, may become garbled over distance and/or time due to noises and other influences in the environment. Garbled and misunderstood communications, such as in a climbing environment for example, may have serious consequences. For example, knowing if he is ‘on belay,’ or not, may make the difference between a climber enjoying the route he is climbing, or wondering if, when he falls, he will ever stop.

A certain portion of the population finds themselves in situations where previous communication devices do not adequately fill the need in environments for which said previous communication devices were not designed. While previous communication devices rely upon satellite, long-distance radio, and other forms of sending messages across extremely long distances, the embodiment of the previously disclosed is designed to successfully send communications in the previously described environments.

### BRIEF DESCRIPTION OF THE DRAWINGS

The appended drawings contain figures of various example embodiments to further illustrate and clarify the above and other aspects of example embodiments of the present invention. It will be appreciated that these drawings depict only example embodiments of the invention and are not intended to limit its scope. Example embodiments of the invention will be described and explained with additional specificity and detail through the use of the accompanying drawings.

FIG. 1 is a top view of an embodiment of the invention.

FIG. 2 is a schematic disclosing various components of an embodiment of the invention.

FIG. 3 is a top view of an embodiment of the invention.

FIG. 4 is a top perspective view of a grip element of an embodiment of the invention.

FIG. 5 is a bottom perspective view of a main interior casing of an embodiment of the invention.

FIG. 6 is side view disclosing a grip element and main interior casing of an embodiment of the invention.

FIG. 7 is a top view of another example embodiment of the invention.

FIG. 7a discloses an example status update scheme.

FIG. 8 discloses an example use configuration of an embodiment of the invention.

FIG. 9 discloses aspects of an example method.

FIG. 10-23 disclose aspects of one alternative embodiment of the invention.

### DETAILED DESCRIPTION OF SOME EXAMPLE EMBODIMENTS

Example embodiments of the invention embrace a wireless communication system and wireless communication device(s) that, among other things, may enable users to communicate both in line-of-sight environments, and obstructed sightline environments. At least some embodiments of the invention are configured to enable a first user, such as a climber for example, to communicate her status to a second user, such as a belayer for example, without requiring that either user employ verbal communication of any kind. Examples of status information that may be communicated from one user to another user may include, but are not limited to, ‘on belay,’ ‘off belay,’ ‘climb,’ ‘take,’ ‘slack,’ ‘trouble/need help,’ and/or any other status information. As well, communications may be sent from the first user to the second user, and/or from the second user to the first user. In some instances, embodiments of the invention may be employed to enable more than two users to communicate with each other.

It is noted that the use of embodiments of the invention is not limited to climbing environments. Rather, embodiments of the invention may, more generally, be employed in any environment or circumstance where verbal communication between/among multiple users, whether aided or unaided by communication systems and devices, is impractical, or impossible.

Example embodiments of the invention may be referred to herein as a ‘short range status communication device.’ One particular, but non-limiting, embodiment of a short range status communication device may have the following features and characteristics: signal transmission/reception range of about 250 feet to 350 feet obstructed, and about 900 feet to 1100 feet unobstructed, that is, line-of-sight; weight of about 7-9 ounces; battery life of about 270 hours to about 330 hours; impact rating of IMX7; water-resistant, or watertight, housing; range of operating temperatures of about −40 F to about +130 F. At least some embodiments may comprise a housing that prevents the ingress of dust and other foreign matter.

It is noted that the embodiments disclosed herein do not constitute an exhaustive summary of all possible embodiments. It should be noted that nothing herein should be construed as constituting an essential or indispensable element of any invention or embodiment. Rather, and as the person of ordinary skill in the art will readily appreciate, various aspects of the disclosed embodiments may be combined in a variety of ways so as to define yet further embodiments. Such further embodiments are considered as being within the scope of this disclosure.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth herein. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

One advantageous aspect of at least some embodiments of the invention is that an embodiment of the invention may eliminate the need for guesswork or assumptions on the part of the user who has a need to know the status of another user. Particularly, such an embodiment of the invention may be advantageous inasmuch as the embodiment may provide for reliable and effective wireless communication of status information between users, the embodiment may eliminate the need for the use of verbal communications which may be unreliable and/or ineffective, due to environmental and/or other factors. An embodiment of the invention may enable a user to select, from a group of pre-programmed statuses, a status and then transmit that status, rather than having to formulate and articulate a message to another user. As well, the relative simplicity of selecting and transmitting a status may be advantageous in variety of circumstances. For example, if the user transmitting the status is injured, or suffering from the influence of heat/cold, simply selecting a status on a wireless device according to an embodiment of the invention may be simpler and easier for the user than attempting to formulate and transmit a coherent status or message, verbally, to another user, whether with or without the aid of a conventional wireless communication device.

### A. ASPECTS OF SOME EXAMPLE EMBODIMENTS

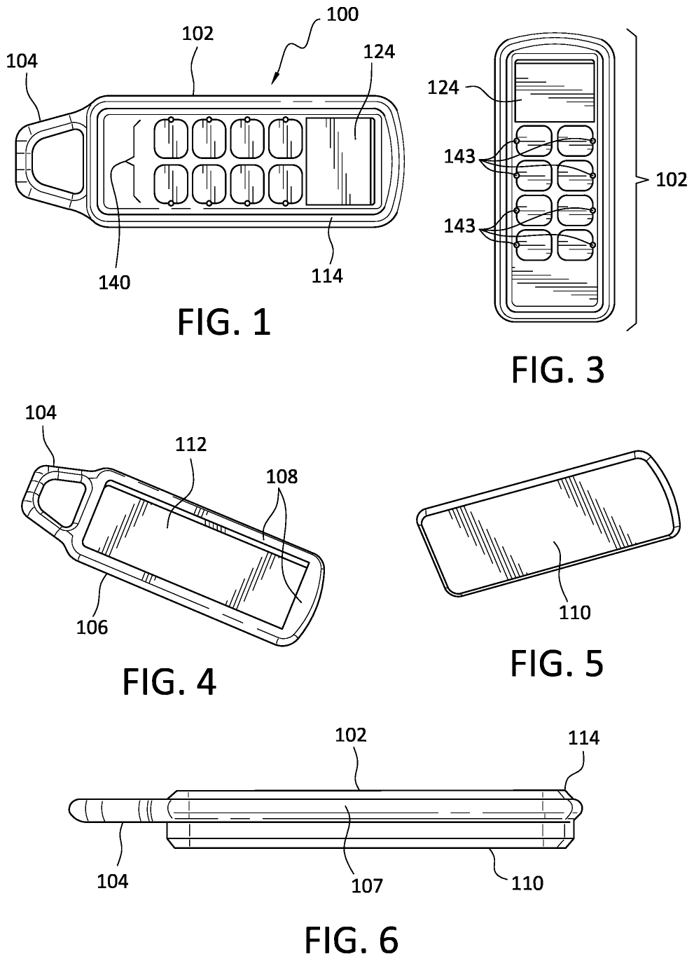

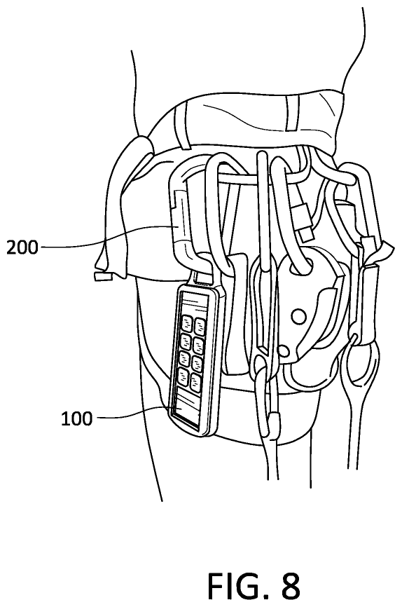

With reference now to FIGS. 1-8, an example ‘short range status communication device’ (SRSCD) according to one embodiment of the invention is denoted generally at 100. In some circumstances, the SRSCD 100 may be employed in pairs, with one unit employed by a transmitting user and another unit employed by a receiving user. In such an arrangement, the transmitting user may employ her SRSCD 100 to transmit a status to the SRSCD 100 of the receiving user. In other embodiments, multiple transmitting users may employ a respective SRSCD 100 and transmit to an SRSCD 100 of a single receiving user, and/or transmit to respective SRSCD 100 units of multiple receiving users. In some embodiments, a status signal transmitted to the SRSCD 100 of a receiving user may be relayed by that SRSCD 100 to one or more other SRSCD 100 devices. Thus, the initial receiving SRSCD 100 may act as a relay or a repeater in this example. The foregoing arrangements are provided only by way of example and are not intended to limit the scope of the invention.

As noted herein, some embodiments of the SRSCD comprise standalone, single-purpose, devices. However, the scope of the invention is not limited to such implementations. Thus, in other embodiments, any SRSCD function, or any combination of SRSCD functions, may be implemented in a wireless mobile communication device, examples of which include cell phones, GPS-enabled devices, or satellite phones, for example. Where such SRSCD functions are implemented in a cell phone, those functions may, or may not, be implemented by way of an app residing on the cell phone. The app may be downloadable to the cell phone.

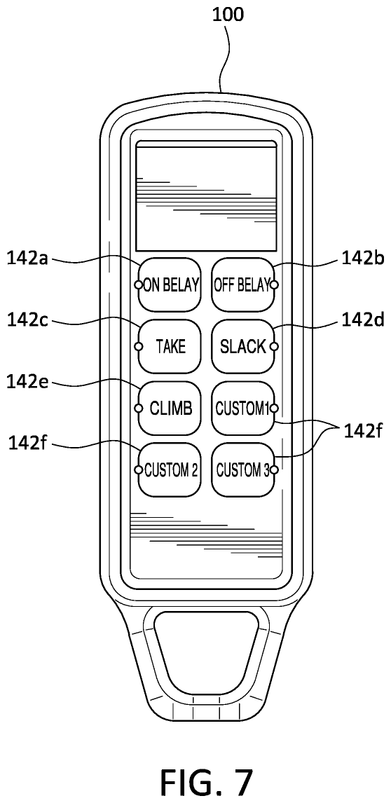

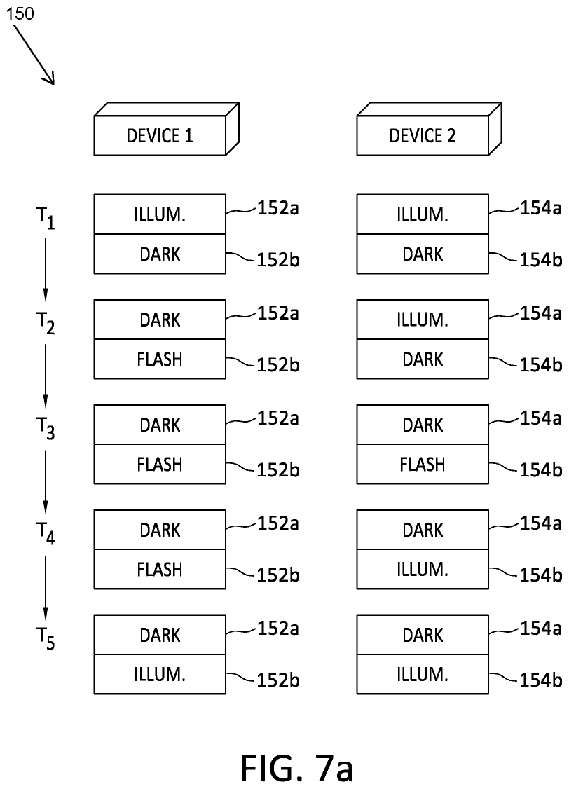

The SRSCD 100 may include, among other things, a casing 102 which may be watertight, such as up to 1 atmosphere, or water resistant. The casing 102 may be made of various materials, such as plastic, rubber, metal such as aluminum and aluminum alloys, or any combination of these. In some embodiments, the casing 102 may comprise a gasket (not shown) or other sealing element to help prevent the ingress of dust, water, and other foreign materials. More generally, any opening in the casing 102 may be sealed by one or more sealing elements. As further indicated in FIG. 1, the casing 102 may include an integral carabiner loop 104, or other attachment device, which may enable the SRSCD 100 to be readily attached to, and detached from, a carabiner 200 or similar device (see, e.g., FIG. 7).

In some embodiments, the casing 102 may be sized to be held in the hand of a user. The casing 102 may include a grip element 106, which may be made of rubber for example, that extends around part, or all, of the casing 102. The grip element 106 may enable a user to grip the casing 102, and/or may help to prevent damage to the SRSCD 100 if the SRSCD 100 were dropped. In some embodiments, the grip element 106 is configured to be disposed about a central casing 108, including the carabiner loop 104. The carabiner loop 104 may be integral with the central casing 108. A main interior casing 110, which may house various components, may be received within an opening 112 defined by the central casing 108. In some embodiments, the grip element 106 may be removable from the central casing 108, and/or the main interior casing 110 may be removable from the central casing 108. As well, the example casing 102 may comprise an elevated and curved lip 114 extending around the external lateral edge of the casing 102 to protect various elements of the SRSCD 100 in the event that the SRSCD 100 were to land face down on a hard surface, such as a rock for example.

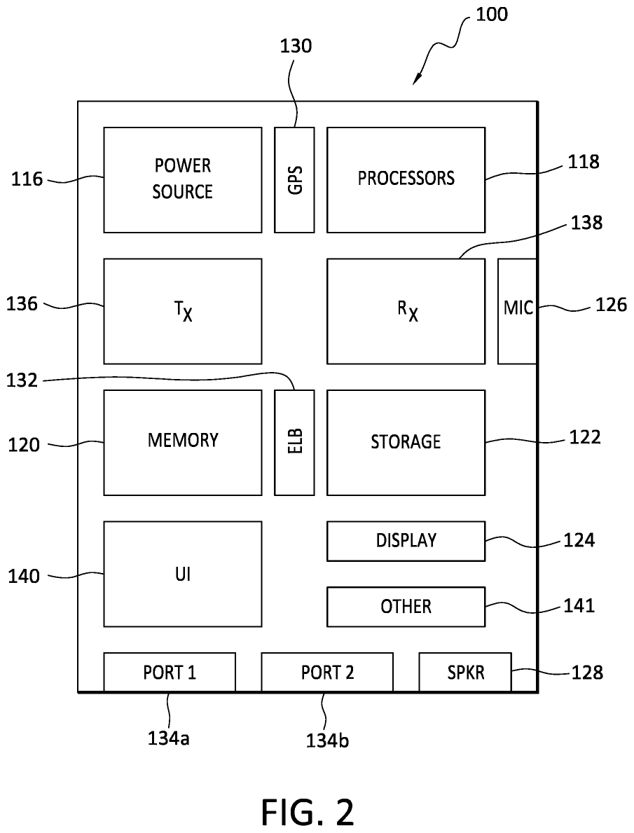

With continue reference to FIG. 1, and turning now to FIG. 2 as well, the SRSCD 100 may include various components that are operable to carry out various operations. One, some, or all, of these components may be partly, or completely, housed within the main interior casing 110. In particular, and with reference to the example of FIG. 2, the SRSCD 100 may include a power source 116 that may be replaceable and/or rechargeable. In some embodiments, the power source 116 may comprise one or more solar cells. The power source 116 may comprise one or more lithium batteries for longer life in cold weather, and the power source 116 may be connected to an ON/OFF switch (not shown), such as a pushbutton or sliding switch, that may enable a user to power up/down the SRSCD 100. The SRSCD 100 may further comprise one or more processors 118 operable to carry out computer-executable instructions which may reside on a non-transitory computer readable media including, but not limited to, one or both of memory 120 and storage 122. Such computer-executable instructions may include, but are not limited to, instructions to carry out any process, function, method, or operation, or any portion of these, disclosed herein, including combinations of any of the foregoing. Examples of memory and storage that may be employed in embodiments of the invention are disclosed elsewhere herein.

With continued reference to FIG. 2 in particular, the SRSCD 100 may include a display 124 which, in some embodiments, may comprise a touch screen display. Information that may be presented to a user by the display 124 may include, but is not limited to, any messages or information that have been encoded into a UI (discussed below), and metrics concerning the SRSCD 100 such as remaining battery life, ambient temperature, elevation (e.g., above sea level), barometric pressure, bearing (that is, direction of travel), and humidity. Respective sensors for obtaining such information may be included in embodiments of the invention.

The SRSCD 100 may also include a microphone 126, and/or a speaker 128. In some embodiments, the speaker 128, possibly in combination with a voice synthesizer, may convert a status signal received from another device, such as ‘take’ for example, into audible status information that may be perceptible by a user of the SRSCD 100. The audible status information may be in addition, or alternative to, status information conveyed by another medium, such as visual signals as discussed below. In some embodiments, the microphone and/or the speaker may be omitted, such that the SRSCD 100 is not able to receive or transmit verbal information, such as verbal status information.

Embodiments of the SRSCD 100 may comprise a global positioning system (GPS) unit 130 configured to transmit and receive position/location information concerning the SRSCD 100. An emergency locator beacon (ELB) 132 may be provided which, when activated by a user, transmits the position of the user to emergency or other services. In some embodiments, the emergency locator beacon 132 may comprise an emergency position-indicating radio beacon (EPIRB) device.

The SRSCD 100 may include various ports 134a and 134b, for example, that may be used to transmit and/or receive power, control signals, and/or, data, to a connected device. Such ports 134a and 134b may comprise, for example, a uniform serial bus (USB) port, or micro USB port. In some embodiments, one of the ports 134a or 134b may be used to recharge the power source 116. The scope of the invention is not limited to any type, or number, of ports.

As further indicated in FIG. 2, the SRSCD 100 may include a transmitter Tx 136 and receiver Rx 138 which operate to transmit and receive, respectively, wireless communication signals, such as to another SRSCD 100 and/or other wireless communication devices. Both the transmitter Tx 136 and receiver Rx 138 may comprise a respective antenna for wireless communication processes involving the SRSCD 100. The GPS unit 130 and ELB 132 may, or may not, comprise separate respective antennas for their respective functions. The transmitter Tx 136 and receiver Rx 138 may operate using any suitable wireless communication protocol, examples of which include, but are not limited to, the Bluetooth protocol discussed herein, and the Wi-Fi wireless communication protocol (e.g., IEEE 802.11). One or both of the antennas may be internal to the SRSCD 100, or external to the SRSCD 100.

A user may use a user interface (UI) 140 of the SRSCD 100 to perform various functions. Such functions may include, for example, powering up/off the SRSCD 100, transmitting status information from the SRSCD 100 to another wireless communication device, and changing the SRSCD 100 between ‘transmit’ (that is, transmit status information) and ‘receive’ (that is, receive status information) modes. The UI 140 may be implemented in a wide variety of forms. In the particular example of FIG. 1, the UI 140 may comprise various user-selectable buttons 142a-142f which may be mechanical or piezoelectric, for example. When depressed or otherwise selected by a user, each of the buttons 142a-142f may transmit a corresponding signal to another SRSCD 100 and/or wireless communication device. Any Other functions 141 may also be provided in the example SRSCD 100, such as one or more of the functions disclosed in connection with alternative embodiments of the SRSCD.

As shown in the example of FIG. 7, one or more of the buttons 142a-142f may correspond to a respective status that the user may send, or that may be sent to a user. Thus, such buttons 142 may respectively correspond to the following status information: ‘on belay’ (142a); ‘off belay’ (142b); ‘take’ (142c); ‘slack’ (142d); and ‘climb’ (142e). As well, one or more buttons 142f may be provided that are associated with respective custom functions that are individually programmable by the user, such as by way of the UI 142 and/or display 124. For example, one of the buttons 142f may be associated with the custom function ‘trouble/need help’ so that when the button 142f is depressed, a signal is transmitted, such as by the ELB 132, to an emergency services provider.

In at least some embodiments, two or more of the statuses are mutually exclusive. For example, the status of a climber cannot be both ‘on belay’ and ‘off belay’ at the same time. Such embodiments may include two or more statuses that are not mutually exclusive. For example, a climber may be ‘off belay’ and in a ‘trouble/help’ status at the same time.

Each of the buttons 142 may comprise a light source 143, such as an LED, LCD, or OLED, for example, that may emit light, cease emitting light, blink on/off, and/or change color, when a signal is transmitted or received that implicates the function with which the particular button 142 is associated. To illustrate, if a climber selects the button 142c designated ‘take slack,’ a light associated with that button 142c may blink on the SRSCD 100 of the climber. After, such as in about 3-5 seconds for example, the climber selects the ‘take’ button 142c, the ‘take’ button of the SRSCD of the belayer may light up and flash until the ‘take’ button 142c is selected on the SRSCD 100 of the belayer. Once selected, the ‘take’ button 142c on the SRSCD 100 of the belayer may remain illuminated until such time as a new status is received from the SRSCD 100 of the climber. After, such as in about 3-5 seconds for example, the belayer selects the ‘take’ button 142c, the light associated with the button 142c designated ‘take’ on the SRSCD 100 of the climber may stop blinking and remain illuminated until the next change to the status of the climber is communicated by the climber to the belayer. In this way, the climber is able to communicate her ‘take slack’ status to the belayer, who may then confirm that ‘take slack’ status to the climber in a manner that is visually, and immediately, apparent to the climber.

It is noted that the dark-flash-illuminated lighting scheme for user-selectable status indicators, such as buttons, is presented only by way of example, and various other schemes may be employed. For example, in an alternative embodiment, the dark-flash-illuminated lighting scheme may be omitted, and a red-yellow-green lighting scheme employed. In this example color scheme, red indicates that the status is not active, yellow indicates that a status change has been requested and is pending, and green indicates a confirmed and current status.

In some embodiments, the SRSCD 100 may vibrate and/or emit a sound when an event occurs that involves the SRSCD 100. Examples of such events include, but are not limited to, selection of a status; receipt of a status signal; confirmation of a status; transmission of a confirmation signal; and, receipt of a confirmation signal. As indicated by these examples, the vibration and/or sound may result from an action taken by a user, and/or from an action performed by an SRSCD 100 in response to user input.

The transmit-and-confirm process that may be implemented by a pair of SRSCD 100 devices may thus eliminate the need for any guesswork on the part of the belayer as to the status of the climber. Further, the climber may be immediately apprised that the belayer is aware of the status of the climber. Thus, uncertainty as to status, and a delay in communicating the status information, may be avoided.

With reference next to FIG. 7a, an example time sequence of events 150 involved in a status change communicated from one SRSCD 100 to another SRSCD 100 is disclosed. In the example of FIG. 7a, it is assumed that each of Device 1 and Device 2 have two, or more, status indicators in common with the other of Device 1 and Device 2. For example, both Device 1 and Device 2 may each have a user-selectable ‘on belay’ status indicator 152a and 152b respectively, and a user-selectable ‘slack’ status indicator 154a and 154b respectively. Finally, the example of FIG. 7a assumes that the user of Device 1 wishes to communicate a change in status to the user of Device 2.

At time T1, both the status indicator 152a of Device 1 and the status indicator 154a of Device 2 are illuminated, while the status indicator 152b of Device 1 and the status indicator 154b of Device 2 are not illuminated, or dark. At time T2, the user of Device 1 transmits status information by selecting status indicator 152b. As a result, status indicator 152b flashes on and off, while status indicator 152a goes dark. Also at time T2, which is a timeframe between when a time Device 1 transmits a status change and a time when Device 2 receives the transmitted status change, the status indicator 154a remains illuminated, and status indicator 154b is not illuminated. That is, at time T2, no status change is indicated yet at Device 2.

At time T3, the status change transmitted by Device 1 has been received at Device 2. As a result, at Device 2, status indicator 154a is no longer illuminated, and status indicator 154b flashes on and off. At Device 1, status indicator 152a remains dark, and status indicator 154a is flashing.

Next, at time T4, the user of Device 2 confirms to the user of Device 1 that the status information transmitted by Device 1 has been received and acknowledged at Device 2. Thus, at Device 2, the status indicator 154a remains dark, while the status indicator 154b is illuminated. As of time T4, Device 1 has not yet received confirmation of the receipt of the status change. Thus, status indicator 152a remains dark, and status indicator 152b continues to flash.

At time T5, the user of Device 1 has received the confirmation transmitted by Device 2. Thus, status indicator 152a remains dark, and status indicator 152b is illuminated. At Device 2, status indicator 154a remains dark, and status indicator 154b is illuminated. Accordingly, as of time T5, the status change initiated by the user of Device 1 at time T1 is complete.

As noted elsewhere herein, various schemes may be employed in connection with user-selectable status indicators. Thus, in one alternative embodiment, the dark, flashing, and illuminated states of the status indicators of FIG. 7a may be omitted and, for example, red, yellow, and green lights, respectively, may be employed instead.

### B. WIRELESS COMMUNICATION

As noted elsewhere herein, embodiments of the invention may be configured to transmit and receive wireless communication signals. Embodiments of the invention may employ any suitable wireless communication components and protocols to this end.

It is noted that characteristics such as transmission and reception range may vary depending upon the particular wireless communication components and protocols employed. By way of illustration, the expected communication range between a Bluetooth transmitter and a Bluetooth receiver operating in an outdoor environment may vary depending upon the physical environment, and the characteristics of the Bluetooth devices. For example, a range (https://www.bluetooth.com/learn-about-bluetooth/bluetooth-technology/rangeMestimator) of communication between a Bluetooth transmitter and a Bluetooth receiver may be about 1469 meters to about 2120 meters, given the following characteristics: transmit power of about 20 dB; transmitter antenna gain of about 10 dBi; receiver antenna gain of about 10 dBi; and, a receiver sensitivity for a Bluetooth PHY (low energy (LE) 125K coded) of about −101. Other effective communication ranges may result from different gain values and transmit power values. For example, a range of communication between a Bluetooth transmitter and a Bluetooth receiver may be about 198 meters to about 276 meters, given the following characteristics: transmit power of about 3 dB; transmitter antenna gain of about 8 dBi; receiver antenna gain of about 3 dBi; and, a receiver sensitivity for a Bluetooth PHY (low energy (LE) 500K coded) of about −99.

The foregoing example estimates are based on certain assumptions that may, or may not, be valid, depending upon the environment. For example, such estimates are based on the Two-Ray Ground Reflection Model for calculating the expected range within typical outdoor environments. The following default settings were used: Link Margin of 15 dB; a Tx Antenna Height of 1 meter; and, a Rx Antenna Height of 1 meter. Thus, it will be appreciated that the effective range of communication between two or more Bluetooth-enabled devices may vary and, as such, the foregoing communication ranges are presented only by way of illustration, and are not intended to limit the scope of the invention in any way.

The scope of the invention is not limited, however, to Bluetooth capable devices and the Bluetooth protocol. More generally, any other devices and protocols that are suitable for use in connection with embodiments of the invention may be employed.

### C. ASPECTS OF SOME EXAMPLE METHODS

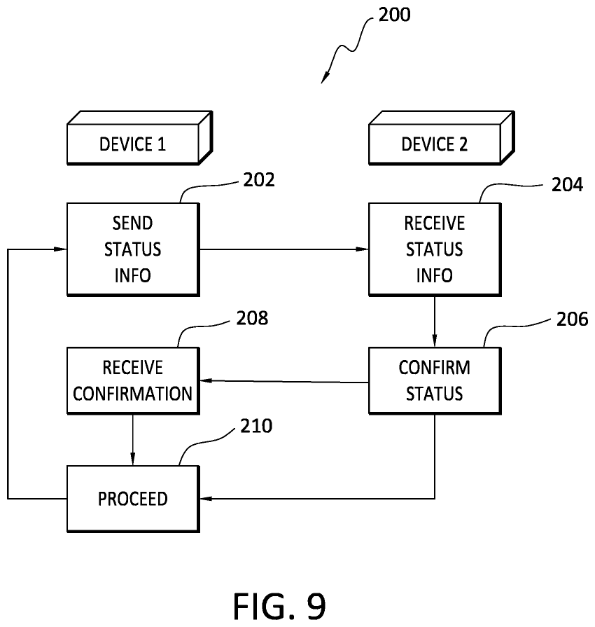

With reference next to FIG. 9, details are provided concerning methods for providing and confirming status information, where one example method is denoted generally at 200. In at least some embodiments, the method 200 may be cooperatively performed with a pair of SRSCD devices, examples of which are disclosed herein. As well, the method 200 may be performed in an environment where verbal communication between the parties involved may be impractical, or impossible, even if wireless communication devices were used to attempt to communicate verbal information between the parties.

The method 200 may begin when a first user causes Device 1 to transmit 202 status information concerning the user. The transmitted status information may be any information that the user wishes to (i) transmit, and (ii) receive confirmation of the receipt of by another user. In one example environment, the user of Device 1 is a climber who transmits information about his status by selecting a particular status button or other input element on Device 1.

The transmitted status information may be received 204 by a second user with Device 2. The use of Device 2 may confirm 206 receipt of the information transmitted 202 by the first user of Device 1. Confirmation 206 may comprise selection, by the second user of Device 2, a particular status button or other input element on Device 2. Because Devices 1 and 2 may have the same status buttons, or at least some common status buttons, the second user of Device 2 may select the same button for confirmation 206 as that selected by the first user 202 when transmitting 202 the status information.

After status is confirmed 206 by the user of Device 2, the confirmation signal is received 208 by the first user with Device 1. Next, user 1 and/or user 2, as applicable, may proceed 210 with performance of the action(s) implicated by the current status of user 1. As further indicated in FIG. 9, the method 200 may return to 202 when the first user of Device 1 wishes to indicate a change in his status to the user of Device 2.

### D. ASPECTS OF AN ALTERNATIVE EMBODIMENT

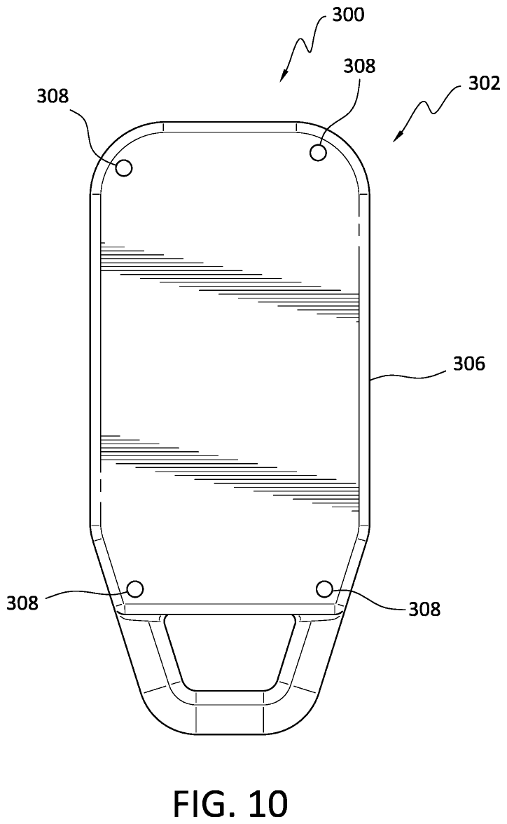

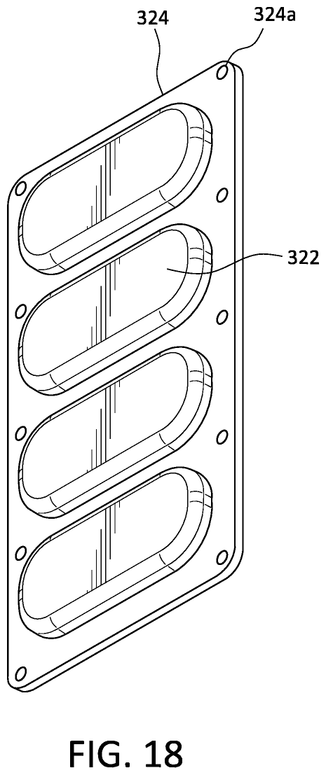

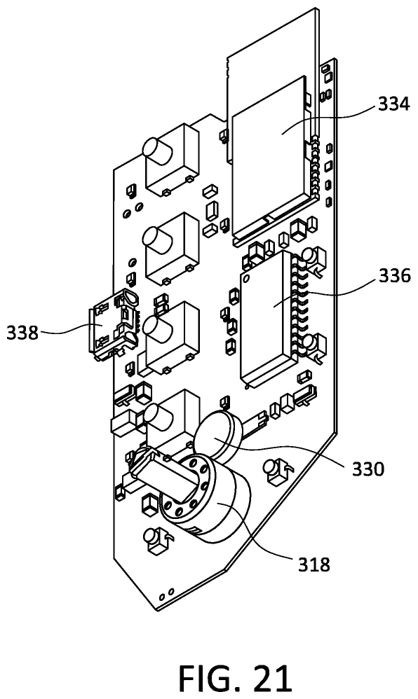

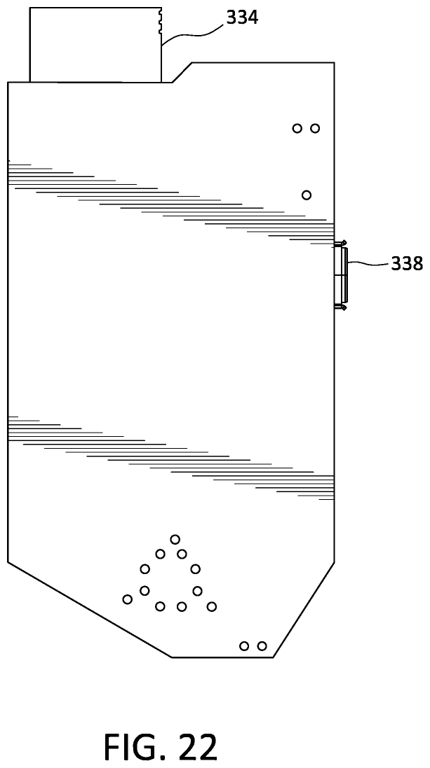

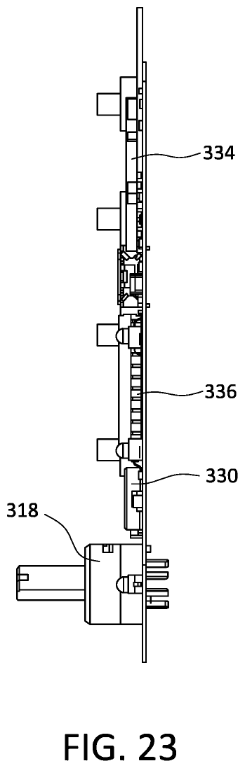

With attention now to FIGS. 10-23, details are provided concerning an alternative embodiment of the invention which is designated generally at 300. Except as may be noted below, the alternative embodiment may be similar, or identical, to embodiments disclosed elsewhere herein. Further, any element of one embodiment may be added to another embodiment, or substituted for an element of another embodiment. As such, embodiments of the invention embrace any combination of any aspects of the various disclosed embodiments.

With reference first to FIGS. 10-16, the SRSCD device 300 may comprise a casing 302 that includes a body 304 to which a cover 306 may be removably attached. The body 304 and/or cover 306 may comprise, for example, plastic, metal, rubber, or any combination of these. The body 304 may comprise an integral clip loop 305. The body 304 and the cover 306 may each take the form of a single piece of material, and one or more sealing elements (not shown) such as a gasket or O-ring for example. The sealing element(s) may, when the body 304 and cover 306 are securely attached together, prevent moisture and other foreign matter from entering into casing 302 interior collectively defined by the body 304 and cover 306. More generally, any opening in the body 304 or cove 306 may be sealed with one or more sealing elements.

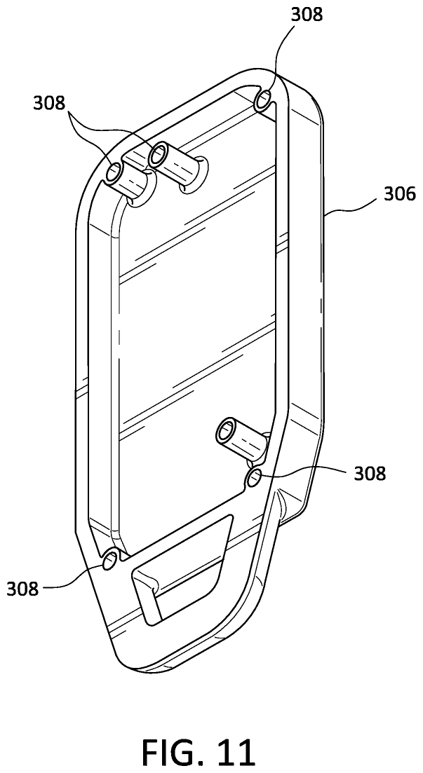

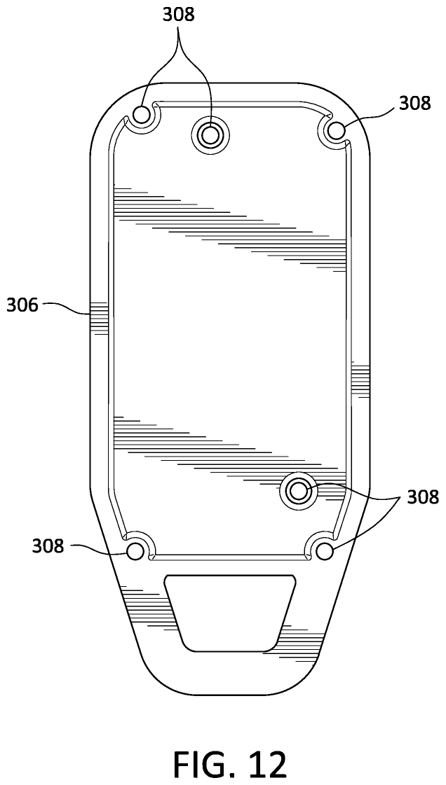

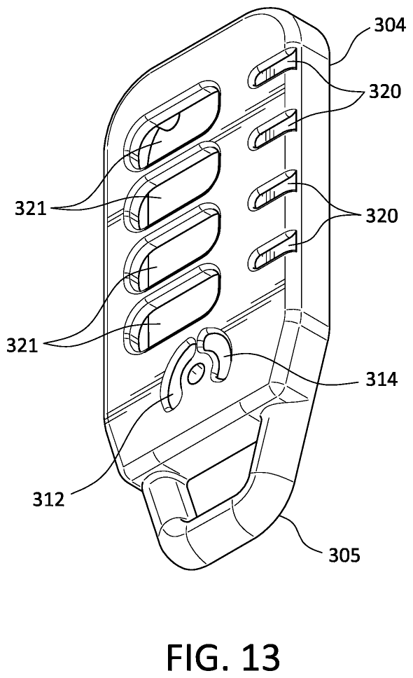

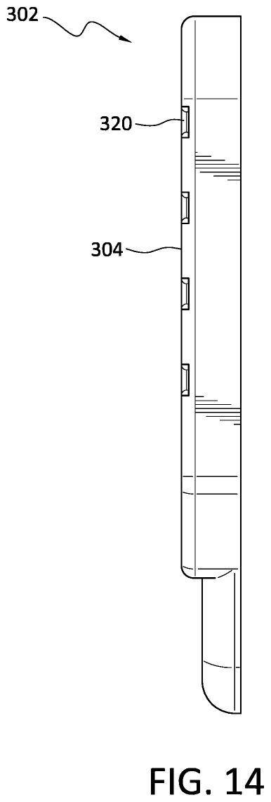

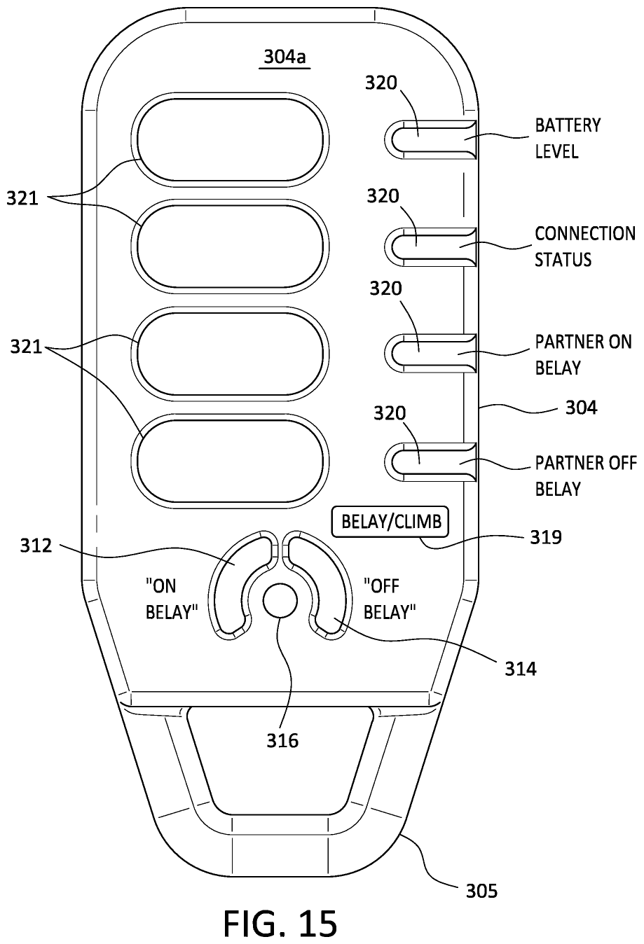

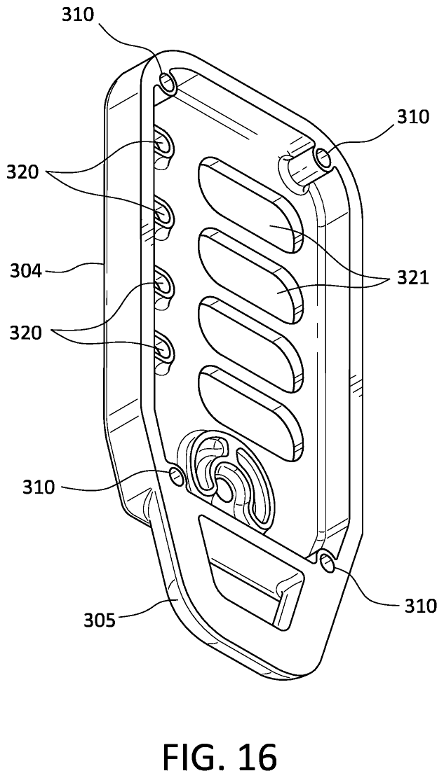

A top view of the body 304 is indicated in FIGS. 13 and 15, and a bottom, or interior, view of the body 304 is indicated in FIG. 16. FIG. 14 discloses a side view of the body 304. As well, FIGS. 11 and 12 disclose a bottom, or interior, view of the cover 306, and FIG. 10 discloses a top view of the cover 306. The cover 306 may be removably attached to the body 304 by one or more fasteners (not shown), such as machine screws for example. The fasteners may pass through respective through holes 308 in the cover 306 and threadingly engage respective threaded engagement portions 310 in the body 304.

With reference to FIGS. 13-16, the body 304 may define respective recesses, spaces, or other features, that each include a respective light source (not shown) such as any of the light sources disclosed herein. For example, recesses 312 and 314 may be defined that each partly, or completely, receive a respective light source. In one example embodiment, an ‘On Belay’ label may be provided proximate the recess 312, and an ‘Off Belay’ label may be provided by the recess 314. As indicated in FIG. 15, an opening 316 may be defined in the body 304 by way of which a portion of a selector switch 318 may be received. In some embodiments, the selector switch 318 comprises a rotatable dial that extends through the opening 316 so as to be accessible by the user.

The selector switch 318 may be operable to enable the user to indicate her on/off belay status by rotating, or sliding, the selector switch 318 either to the left, to illuminate the ‘On Belay’ status indicator, or to the right to illuminated the ‘Off Belay’ status indicator. If the user of the SRSCD 300 is the belayer, rather than the climber, the selector switch 318 may be positioned in a neutral position between the ‘On Belay’ and ‘Off Belay’ positions. When the selector switch 318 is in the neutral position, both the ‘On Belay’ and ‘Off Belay’ status indicators may be extinguished.

Additionally or alternatively, the SRSCD 300 may include a 2-position ‘Belay’/‘Climb’ selector switch 319 to enable the user to set his device according to his anticipated role as either belayer or climber. In some embodiments, an error indicator such as one or more of a light, vibration, or sound, may be emitted by the SRSCD 300 of each user if both users have inadvertently selected the same role.

The light sources received in recesses 312 and 314 may comprise green LEDs so that when the selector switch 318 of the climber device is set to ‘On Belay,’ the green LED in recess 312 of the climber device is illuminated, while the green LED in recess 314 is extinguished. Similarly, when the selector switch 318 of the climber device is set to ‘Off Belay,’ the green LED in recess 314 of the climber device is illuminated, while the green LED in recess 312 is extinguished. With this arrangement, the user must take an affirmative action to change her status, and to communicate that status change to the other user.

With continued reference to FIGS. 13 and 15 in particular, the body 304 may define a plurality of recesses 320 each configured and arranged to receive a respective light source, or group of light sources (not shown) that illuminate to provide information to the user. For example, the uppermost recess 320 (FIG. 15) may include green, yellow, and red, light sources indicating respective states of a battery level, that is, good/low/dead. The next lower recess 320 may include green, and red, light sources that when illuminated indicate, respectively, that or the user SRSCD device is connected (green) to, that is, communicating with, the partner SRSCD device, or that the user SRSCD device is not connected (red) to the partner SRSCD device.

The bottom two recesses 320 may respectively include a single green light source which, when illuminated, indicates that the partner is on belay, or the partner is off belay, respectively. When the light source indicating the partner is on belay is illuminated, the light source indicating the partner is off belay may be extinguished, and when the light source indicating the partner is off belay is illuminated, the light source indicating the partner is on belay may be extinguished. With this scheme, any question as to the status of the partner may be eliminated.

With continuing reference to FIG. 15, if the user of the illustrated SRSCD 300 is the climber, the ‘Partner On Belay’ and ‘Partner Off Belay’ lights respectively received in the indicated recesses 320 may both be extinguished. In some embodiments, movement of the selector switch 319, if provided, to the ‘Climb’ mode may automatically extinguish the aforementioned lights.

On the other hand, if the user of the illustrated SRSCD 300 is the belayer, the ‘Partner On Belay’ and ‘Partner Off Belay’ lights respectively received in the indicated recesses 320 may be illuminated or extinguished, consistent with the status indicated by the climber and received by the belayer. Particularly, the ‘Partner On Belay’ and ‘Partner Off Belay’ status lights convey information to the belayer concerning the status of the climber, where that status is conveyed, as discussed earlier, when the climber moves the selector switch 318 to ‘On Belay’ or ‘Off Belay.’ That is, when the climber moves his selector switch 318 to ‘On Belay,’ the ‘Partner on Belay’ status light of the belayer SRSCD may be illuminated green. In this way, the belayer knows that her partner status is ‘On Belay.’ In similar fashion, when the climber moves his selector switch 318 to ‘Off Belay, the ‘Partner Off Belay’ status light of the belayer SRSCD may be illuminated green, and the ‘Partner on Belay’ status light extinguished. In this way, the belayer knows that her partner status is ‘Off Belay.’

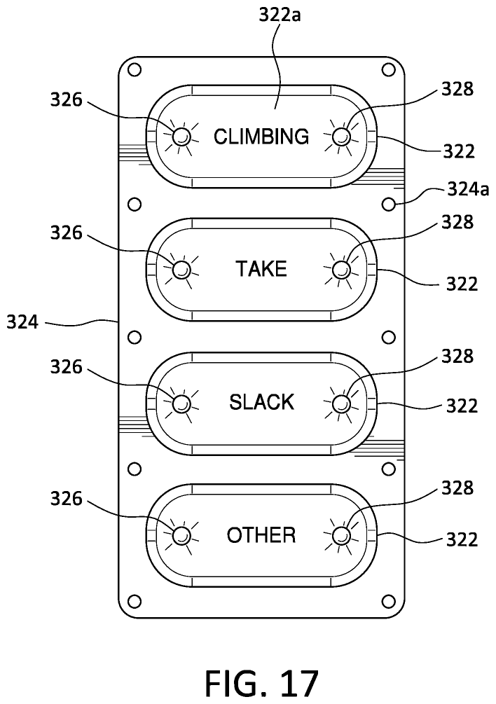

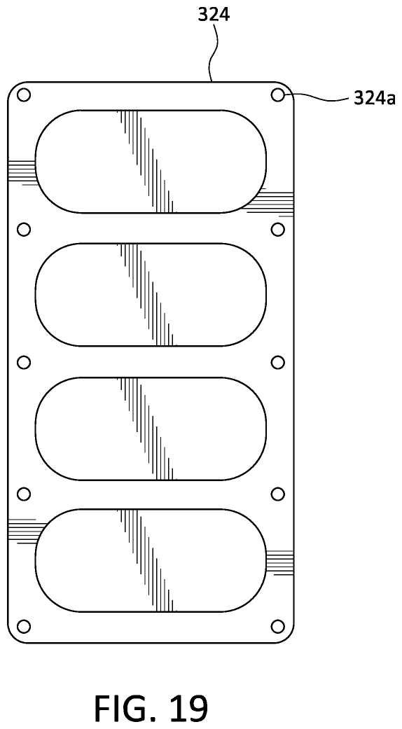

As further indicated in FIGS. 13 and 15, the body 304 may define a plurality of openings 321 each configured to accommodate a portion of a respective button 322. The upper surface 322a of each of the buttons 302 may be flush with, or protrude past, an upper surface 304a of the body 304. The buttons 322, which may comprise rubber or plastic for example, and may be integrally formed together as a single piece of material 324, are selectable by the user to indicate her status. The single piece of material 324 may include through holes 324a to accommodate fasteners joining the body 304 and the cover 306, and an underside view of the single piece of material 324 is indicated in FIG. 19. In general, the theory of operation of the buttons 322 may be similar or identical to the theory of operation of the status indicators of the other embodiments disclosed herein. In the particular example of FIG. 17, respective buttons may be provided for the statuses of ‘climbing,’ ‘take,’ ‘slack,’ and ‘other.’ Note that in the embodiment of FIGS. 10-23, a display screen is omitted from the SRSCD.

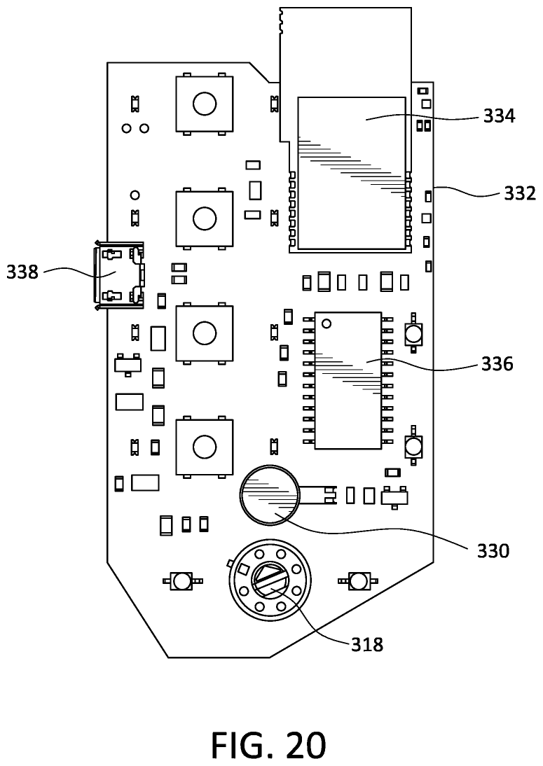

In some embodiments, the buttons 322 may comprise a translucent portion that passes light emitted by one or more light sources positioned beneath the button 322. In some embodiments, two light sources are provided for each button 322. A left hand light source 326 may, when illuminated, indicate that the user pressed the ‘climbing’ button 322, and when the right hand light source 328 is illuminated, either in addition or alternatively, to the left hand light source 326, the user knows that his partner has confirmed the indication by the user of the ‘climbing’ status of the user. As well, a vibration motor 330 (see FIG. 20) may vibrate upon confirmation, by the partner, of the status indicated by the user. Similar light sources 326 and 328 are provided for the other buttons 322 as well.

With reference now to FIGS. 20-23, details are provided concerning aspects of the circuitry included in the SRSCD 300. For example, the printed circuit board 332 may comprise a Bluetooth low energy module having a memory, antenna, and processors operable to carry out various functions of the SRSCD 300. Finally, the SRSCD 300 may include a long range module 334, such as the Fanstel BT832X (https://www.fanstel.com/bt832x-bluetooth-5-module) for example. The BT832X module is a Bluetooth 5 module with power amplifier and has a range, with another module of the same type, of about 1140 meters when the respective antennas are about 4.2 meters above the ground. Below are specifications for the BT832X:

BT832X, Bluetooth 5 Module with Power Amplifier

BT832X is a Nordic nRF52832 module with Skyworks SKY66112 power amplifier. With over +20 dBm TX power, Bluetooth range between two modules is 1140 meters.

Sister module, BT832XE, is with Power Amplifier and an u. FL Connector for external antenna.

Bluetooth Range Measurements and Recommendations

Summaries:
Both antennas at 4.2 meters above ground, average range is 1140 meters.
Both antennas at 1.52 meters (5 feet, typical height of thermostat in the USA), range is 1120 meters.
At high obstruction, BT832X range degradation is much smaller than other modules.
With +20 dBm TX, BT832X is much better in wall penetration than other modules for indoor applications.

Specifications
Nordic nRF52832 QFAA with ARM Cortex M4F (M4 for nRF52810 module)
512 KB flash, 64 KB RAM (192 KB flash/64 KBRAM for nRF52810 module)
Complete RF solution with integrated antenna.
TX power with antenna gain: over +20 dBm.
NFC-A tag interface for Out Of Band pairing.
128-bit AES HW encryption
Serial Wire Debug (SWD)
Nordic SoftDevice Ready
Over-The-Air (OTA) firmware update

32 GPIOs, firmware configurable and Peripherals
12 bit/200 KSps ADC, 8 configurable channels with programmable gain
Type 2 near field communication (NFC-A) tag
64 level comparator
15 level low power comparator with wake-up from system OFF mode
Temperature sensor
3×4-channel pulse width modulator (PWM) units with EasyDMA
Digital microphone interface (PDM)
5×32 bit timers with counter mode
Up to 3× SPI Master/Slave with Easy DMA
Up to 2× I2C compatible 2-wire master/slave
I2S with EasyDMA
UART (CTS/RTS) with EasyDMA
Programmable peripheral interconnect (PPI)
Quadrature Demodulator (QDEC)
AES HW encryption with EasyDMA
Autonomous peripheral operation without CPU intervention using PPI and Easy DMA
3× real time counter (RTC)

Power:
Operation voltage: 1.7V to 3.6V
0.4 uA OFF mode, 1.8 uA idle

Miscellaneous
Operation Temperature: −40° C. to +85° C.
Integrated shield to resist EMI
Sizes: 15×28×1.9 mm
Availability: production.
Unit price: $11.50 each at 1K pcs

Certifications:
FCC ID: X8WBT832XE
IC (Industrial Canada) ID: 4100A-BT832XE

The foregoing is provided only by way of example, and any other module(s) or device(s) of comparable functionality may alternatively be employed. As well, an LED driver 336 may be provided that manages power output for LEDs and/or other light sources of the SRSCD 300 and may help to ensure that all the light sources receive adequate power from a power source (not shown) of the SRSCD 300. Finally, a charging port 338, such as a micro-USB port for example, may be provided to enable charging of a rechargeable power source of the SRSCD 300.

### E. FURTHER EXAMPLE EMBODIMENTS

Following are some further example embodiments of the invention. These are presented only by way of example and are not intended to limit the scope of the invention in any way.

### Embodiment 1

A wireless communication device, comprising: a receiver; a transmitter; a power source connected to the transmitter and receiver; and a group of user-selectable status indicators, each of which are selectable by a user to cause the transmitter to transmit a respective status signal.

### Embodiment 2

The wireless communication device as recited in embodiment 1, wherein the user-selectable status indicators comprise a respective user-selectable status indicator for each of the following statuses: ‘on belay’; ‘off belay’; ‘climb’; ‘take’; and ‘slack.’

### Embodiment 3

The wireless communication device as recited in any of embodiments 1-2, further comprising a respective light source associated with each of the user-selectable status indicators, and each of the light sources is operable to assume any of three different states, each of which corresponds to a particular status.

### Embodiment 4

The wireless communication device as recited in any of embodiments 1-3, wherein the three different states are inactive, status change requested/pending, and status change confirmed/current.

### Embodiment 5

The wireless communication device as recited in any of embodiments 1-4, wherein the wireless communication device is unable to receive or transmit verbal information.

### Embodiment 6

The wireless communication device as recited in any of embodiments 1-5, wherein receipt of a confirmation signal by the receiver causes a corresponding user-selectable status indicator to assume one of three different states.

### Embodiment 7

The wireless communication device as recited in any of embodiments 1-6, wherein receipt of a status signal by the receiver causes a corresponding user-selectable status indicator to assume one of three different states.

### Embodiment 8

The wireless communication device as recited in any of embodiments 1-7, wherein a user-selectable status indicator assumes one of three different states until confirmation is received by the communication device that a status signal has been received by another wireless communication device.

### Embodiment 9

The wireless communication device as recited in any of embodiments 1-8, wherein one of the user-selectable status indicators comprises a selector switch movable between a first position and a second position, and the selector switch is operable such that when the selector switch is in the first position, an ‘on belay’ status indicator is illuminated, and when the selector switch is in the second position, an ‘off belay’ status indicator is illuminated.

### Embodiment 10

A method, comprising: transmitting, from a first wireless communication device to a second wireless communication device, a status update signal; displaying, by the first wireless communication device, a pending status that corresponds to the transmitted status update signal; receiving, by the first wireless communication device from the second wireless communication device, a confirmation signal indicating that the second wireless communication device has received the status update signal; and displaying, by the first wireless communication device a confirmed status that corresponds to the confirmation signal.

### Embodiment 11

The method as recited in embodiment 10, further comprising changing a displayed active status after transmitting the status update signal.

### Embodiment 12

The method as recited in any of embodiments 10-11, wherein the status update signal indicates one of: ‘on belay’; ‘off belay’; ‘climb’; ‘take’; or ‘slack.’

### Embodiment 13

The method as recited in any of embodiments 10-12, wherein the confirmation signal indicates one of: ‘on belay’; ‘off belay’; ‘climb’; ‘take’; or ‘slack.’

### Embodiment 14

The method as recited in any of embodiments 10-13, wherein the confirmation signal indicates the same status as the status update signal.

### Embodiment 15

The method as recited in any of embodiments 10-14, wherein the first wireless communication device is in an active status at the time that the status update signal is sent, and a status associated with the status update signal is different from the active status.

### Embodiment 16

A method for performing any of the operations, methods, or processes, or any portion of any of these, disclosed herein.

### Embodiment 17

A non-transitory storage medium having stored therein instructions that are executable by one or more hardware processors to perform the method of any of embodiments 10 through 16.

### Embodiment 18

A wireless communication device according to any of embodiments 1-9, and the wireless communication device comprising one or more hardware processors and the non-transitory storage medium of embodiment 17.

### Embodiment 19

A wireless communication device according to any of embodiments 1-9, and the wireless communication device is operable to perform the method according to any of embodiments 10-16.

### F. EXAMPLE COMPUTING DEVICES AND ASSOCIATED MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

While the present disclosure has been described herein with respect to certain illustrated embodiments, those of ordinary skill in the art will recognize and appreciate that it is not so limited. Rather, many additions, deletions, and modifications to the illustrated embodiments may be made without departing from the scope of the disclosure as hereinafter claimed, including legal equivalents thereof. In addition, features from one embodiment may be combined with features of another embodiment to define still further embodiments encompassed within the scope of the disclosure as contemplated by the inventors.

What is claimed is:

1. A wireless communication device, comprising:
a receiver;
a transmitter;
a power source connected to the transmitter and receiver; and
a group of user-selectable status indicators, each of which are selectable by a user to cause the transmitter to transmit a respective status signal.

2. The wireless communication device as recited in claim 1, wherein the user-selectable status indicators comprise a respective user-selectable status indicator for each of the following statuses: ‘on belay’; ‘off belay’; ‘climb’; ‘take’; and ‘slack.’

3. The wireless communication device as recited in claim 1, further comprising a respective light source associated with each of the user-selectable status indicators, and each of the light sources is operable to assume any of three different states, each of which corresponds to a particular status.

4. The wireless communication device as recited in claim 3, wherein the three different states are inactive, status change requested/pending, and status change confirmed/current.

5. The wireless communication device as recited in claim 1, wherein the wireless communication device is unable to receive or transmit verbal information.

6. The wireless communication device as recited in claim 1, wherein receipt of a confirmation signal by the receiver causes a corresponding user-selectable status indicator to assume one of three different states.

7. The wireless communication device as recited in claim 1, wherein receipt of a status signal by the receiver causes a corresponding user-selectable status indicator to assume one of three different states.

8. The wireless communication device as recited in claim 1, wherein a user-selectable status indicator assumes one of three different states until confirmation is received by the communication device that a status signal has been received by another wireless communication device.

9. The wireless communication device as recited in claim 1, wherein one of the user-selectable status indicators comprises a selector switch movable between a first position and a second position, and the selector switch is operable such that when the selector switch is in the first position, an ‘on belay’ status indicator is illuminated, and when the selector switch is in the second position, an ‘off belay’ status indicator is illuminated.

10. A method, comprising:
transmitting, from a first wireless communication device to a second wireless communication device, a status update signal;
displaying, by the first wireless communication device, a pending status that corresponds to the transmitted status update signal;
receiving, by the first wireless communication device from the second wireless communication device, a confirmation signal indicating that the second wireless communication device has received the status update signal; and
displaying, by the first wireless communication device a confirmed status that corresponds to the confirmation signal.

11. The method as recited in claim 10, further comprising changing a displayed active status after transmitting the status update signal.

12. The method as recited in claim 10, wherein the status update signal indicates one of: ‘on belay’; ‘off belay’; ‘climb’; ‘take’; or ‘slack.’

13. The method as recited in claim 10, wherein the confirmation signal indicates one of: ‘on belay’; ‘off belay’; ‘climb’; ‘take’; or ‘slack.’

14. The method as recited in claim 10, wherein the confirmation signal indicates the same status as the status update signal.

15. The method as recited in claim 10, wherein the first wireless communication device is in an active status at the time that the status update signal is sent, and a status associated with the status update signal is different from the active status.

16. A non-transitory storage medium having stored therein instructions that are executable by one or more hardware processors to perform operations comprising:
transmitting, from a first wireless communication device to a second wireless communication device, a status update signal;
displaying, by the first wireless communication device, a pending status that corresponds to the transmitted status update signal;
receiving, by the first wireless communication device from the second wireless communication device, a confirmation signal indicating that the second wireless communication device has received the status update signal; and
displaying, by the first wireless communication device a confirmed status that corresponds to the confirmation signal.

17. The non-transitory storage medium as recited in claim 16, further comprising changing a displayed active status after transmitting the status update signal.

18. The non-transitory storage medium as recited in claim 16, wherein:
the status update signal indicates one of: ‘on belay’; ‘off belay’; ‘climb’; ‘take’; or ‘slack;’ and
the confirmation signal indicates one of: ‘on belay’; ‘off belay’; ‘climb’; ‘take’; or ‘slack.’

19. The non-transitory storage medium as recited in claim 16, wherein the confirmation signal indicates the same status as the status update signal.

20. The non-transitory storage medium as recited in claim 16, wherein the first wireless communication device is in an active status at the time that the status update signal is sent, and a status associated with the status update signal is different from the active status.
